(19) United States
(12) Patent Application Publication
(10) Pub. No.: US 2011/0156889 A1
(43) Pub. Date: Jun. 30, 2011

(54) VEHICLE WARNING SYSTEM AND METHOD

(75) Inventor: MING-YANG LIAO, Tu-Cheng (TW)

(73) Assignee: HON HAI PRECISION INDUSTRY CO., LTD., Tu-Cheng (TW)

(21) Appl. No.: 12/693,366

(22) Filed: Jan. 25, 2010

(30) Foreign Application Priority Data
Dec. 28, 2009 (TW) 98145203

(51) Int. Cl. B60Q 1/00

(52) U.S. Cl. 340/435

(57) ABSTRACT

A warning system for a stopped vehicle includes an alarm device for mounting in the stopped vehicle, and a warning sign for being placed away from the stopped vehicle in the direction of oncoming traffic. The warning sign includes a display module, an image capturing module, an image processing module, and a signal transmission module. The image capturing module is configured for capturing images of the traffic on the road adjacent to the stopped vehicle. The image processing module is configured for receiving the images from the image capturing module and controlling the signal transmission module to transmit a signal to the alarm device if the moving speed toward the stopped vehicle of the moving object is greater than a predetermined speed. The alarm device is configured for generating an alarm for alarming the person in the stopped vehicle in response to the signal.

### BACKGROUND

1. Technical Field

The present disclosure relates to warning systems, and particularly to a warning system and method for vehicles such as a car in traffic.

2. Description of Related Art

When a car is stopped in the road for an emergency flares and/or reflective warning signs should be setup to warn approaching vehicles of the hazardous condition. Although useful to warn other drivers, these methods do not warn the driver and occupants of the stopped car of the hazard of a quickly approaching vehicle.

Therefore, a new type of warning system and method for a stopped vehicle in the roadway is desired to overcome the above described shortcoming.

### BRIEF DESCRIPTION OF THE DRAWINGS

FIG. 1 is a schematic view of a warning system for a stopped vehicle in a road in accordance with an exemplary embodiment.

FIG. 2 is a block diagram illustrating the warning system of FIG. 1.

### DETAILED DESCRIPTION

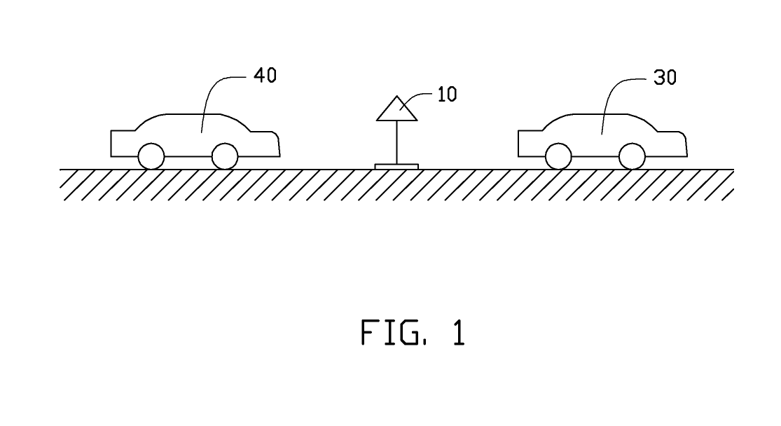

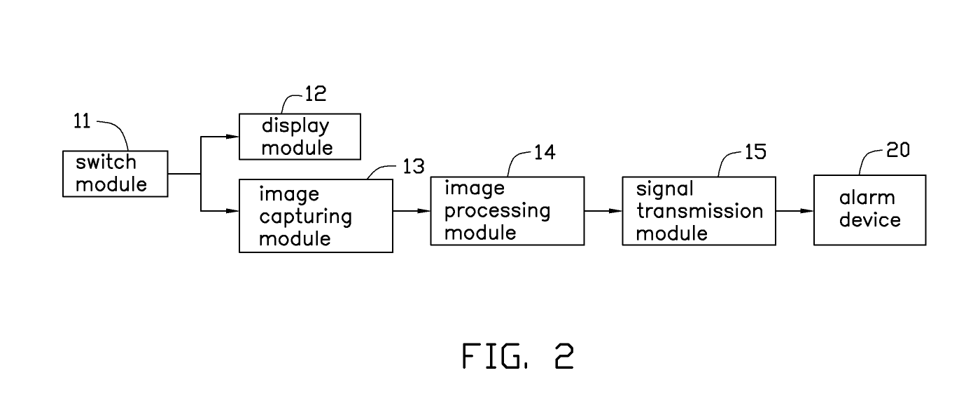

FIGS. 1-2 show a warning system for a stopped vehicle 30 in accordance with an embodiment of the present disclosure. The warning system includes a warning sign 10 and an alarm device 20. The alarm device 20 is mounted in the stopped vehicle 30. The warning sign 10 is placed away from the stopped vehicle 30 in the direction of oncoming traffic, that is, in the lane the stopped vehicle 30 is stopped in at a predetermined distance that should be far enough away that oncoming traffic will have sufficient time to maneuver to avoid colliding with the stopped vehicle 30.

The warning sign 10 includes a switch module 11, a display module 12, an image capturing module 13, an image processing module 14 and a signal transmission module 15. The switch module 11 is connected to the display module 12 and the image capturing module 13, and configured for controlling on/off of the display module 12 and the image capturing module 13. The image processing module 14 is connected to the image capturing module 13, and the signal transmission module 15 is connected to the image processing module 14.

When the switch module 11 is switched on, the display module 12 displays a warning symbol for warning an oncoming vehicle 40 that the stopped vehicle 30 is stopped ahead in the way. In the illustrated embodiment, the display module 12 is a light-emitting diode (LED) alarming lamp. When the switch module 11 is switched on, the image capturing module 13 captures images of the traffic on the road adjacent to the stopped vehicle 30 and transmits the captured images to the image processing module 14. The image processing module 14 receives the road images from the image capturing module 13 and determines whether there is a moving object in the road images and whether the moving speed toward the stopped vehicle 30 of the moving object is greater than a predetermined speed, that is, faster than a speed considered safe for the person in stopped vehicle 30 to take evasive action to avoid the moving object. The image processing module 14 controls the signal transmission module 15 to transmit a wireless signal to the alarm device 20 if the moving speed toward the stopped vehicle 30 of the moving object is greater than the predetermined speed. The alarm device 20 generates an alarm for alarming the person in the stopped vehicle 30 in response to the wireless signal.

The warning system helps monitor traffic behind the stopped vehicle 30. When a moving object comes towards the stopped vehicle 30 in view of the warning sign 10, the alarm system warns the persons in the stopped vehicle 30 so that they may have a chance to take evasive action.

A warning method for the stopped vehicle 30 is described as follows.

Firstly, the display module 12 is displayed with a warning symbol for alarming the oncoming vehicle 40 behind the warning sign 10 that the stopped vehicle 30 is stopped ahead after the switch module 11 is switched on. Then the image capturing module 13 captures road images of the traffic on the road adjacent to the stopped vehicle 30. The image processing module 14 receives the road images and determines whether there is a moving object in the road images and whether the moving speed toward the stopped vehicle 30 of the moving object is greater than a predetermined speed. The image processing module 14 controls the signal transmission module 15 to transmit a wireless signal to the alarm device 20 if the moving speed toward the stopped vehicle 30 of the moving object is greater than a predetermined speed. When the alarm device 20 receives the wireless signal, the alarm device 20 is triggered and generates an alarm for alarming the person in the stopped vehicle 30 that there is a moving object coming from behind the warning sign 10 and rushing towards the stopped vehicle 30.

It is to be understood, however, that even though numerous characteristics and advantages of the disclosure have been set forth in the foregoing description, together with details of the structures and functions of the embodiment(s), the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A warning system for a stopped vehicle, comprising:
an alarm device for mounting in the stopped vehicle; and
a warning sign for being placed away from the stopped vehicle in the direction of oncoming traffic, the warning sign comprising:
a display module configured for displaying a warning symbol for warning an oncoming car;
an image capturing module being configured for capturing images of the traffic on the road adjacent to the stopped vehicle;
an image processing module connected to the image capturing module, the image processing module being configured for receiving the images from the image capturing module and determining whether there is a moving object in the road images; and
a signal transmission module connected to the image processing module; wherein the image processing module configured for controlling the signal transmission module to transmit a signal to the alarm device if the moving speed toward the stopped vehicle of the moving object is greater than a predetermined speed, the alarm device configured for generating an alarm for alarming the person in the stopped vehicle in response to the signal.

2. The warning system of claim 1, wherein the signal transmission is configured for transmitting a wireless signal to the alarm device.

3. The warning system of claim 1, wherein the display module is an LED alarming lamp.

4. The warning system of claim 1, wherein the warning sign further comprises a switch module, the switch module is connected to the display module and the image capturing module and configured for controlling on/off of the display module and the image capturing module.

5. A warning method for a stopped vehicle, comprising:
displaying a warning sign for alarming an oncoming car using a display module;
image capturing module capturing images of the traffic on the road adjacent to the stopped vehicle using an image capturing module;
receiving the images from image capturing module and determining whether there is a moving object in the images and whether the moving speed toward the stopped vehicle of the moving object is greater than a predetermined speed using an image processing module;
transmitting a signal to an alarm device in the stopped vehicle using a signal transmission module if the moving speed toward the stopped vehicle of the moving object is greater than a predetermined speed, whereby the warning device is triggered to generate an alarm for alarming the person in the stopped vehicle.

6. The warning method of claim 5, wherein the signal transmission module transmits a wireless signal to the alarm device.

7. The warning method of claim 5, wherein the display module is an LED alarming lamp.

8. The warning method of claim 5, wherein the display module, the image processing module and signal transmission module are incorporated in the warning sign, the warning sign is placed a distance away from the stopped vehicle in the direction of oncoming traffic.

9. The warning method of claim 8, wherein the image processing module is connected to the image capturing module, and the signal transmission module is connected to the image processing module.

10. The warning method of claim 8, wherein the warning sign further comprises a switch module, the switch module is connected to the display module and the image capturing module and configured for controlling on/off of the display module and the image capturing module.
